(19) United States
(12) Patent Application Publication
(10) Pub. No.: US 2026/0340284 A1
(43) Pub. Date: Oct. 29, 2026

(54) SYSTEM, METHOD, AND COMPUTER PROGRAM PRODUCT FOR PREDICTING INPUT FORM FIELDS USING BEHAVIORAL MODELING

(71) Applicant: BILL Operations, LLC, San Jose, CA (US)

(72) Inventors: Changlin Zhang, Saratoga, CA (US); Xiaojuan Tian, Cupertino, CA (US); Rohan Jha, San Jose, CA (US); Johnny Lee, Richmond, CA (US); Greg DeRosa, Herndon, VA (US); Gaurav Tandon, Sammamish, WA (US); Mohsen Sardari, Burlingame, CA (US); Max Stepin, Redmond, WA (US); Ken Moss, Menlo Park, CA (US)

(21) Appl. No.: 19/190,469

(22) Filed: Apr. 25, 2025

(51) Int. Cl. G06F 40/274; G06F 11/34; G06F 40/197; G06F 40/284; G06V 30/148

(52) U.S. Cl. CPC G06F 40/274; G06F 11/3438; G06F 40/197; G06F 40/284; G06V 30/153

(57) ABSTRACT

System, method, and computer program product for predicting input form fields using behavioral modeling is disclosed herein. In use, documents are analyzed and user input is collected. Individual and collective behavioral patterns are detected from the analyzed documents and collected user input. The detected behavioral patterns are validated based on repeatability and explainability criteria. Validated behavioral patterns are stored. Stored behavioral patterns are applied to generate predictions for new documents.

### FIELD OF THE INVENTION

The present disclosure relates to document processing systems, and more particularly to predicting input form fields in documents using behavioral modeling and user feedback.

### BACKGROUND

Document processing systems face significant challenges in accurately predicting and populating input form fields, particularly when dealing with incomplete or ambiguous information. This issue has become increasingly important as organizations seek to streamline their data entry processes and improve efficiency in handling large volumes of documents.

Existing systems attempting to address this problem encounter several obstacles. These include difficulties in interpreting diverse document formats, limited ability to infer missing information, and lack of adaptability to individual user behaviors. Such limitations reduce the effectiveness of automated form filling, often requiring substantial manual intervention and increasing the likelihood of errors.

For instance, in scenarios where a document lacks specific fields required for form completion, current solutions may fail to generate accurate predictions or leave fields blank. Another example is when processing invoices from various vendors, where existing methods are unable to consistently identify and populate fields that differ in format or naming conventions across documents. These shortcomings result in increased processing time, reduced accuracy, and a higher workload for users who must manually review and correct automated entries.

As such, there is thus a need for addressing these and/or other issues associated with the prior art.

### SUMMARY

In some aspects, the techniques described herein relate to a computer program product for detecting and validating behavioral patterns in document processing, the computer program product including a computer readable storage medium having program instructions embodied therewith, the program instructions executable by a processor to cause the processor to: analyze documents and collect user input; detect individual and collective behavioral patterns from the analyzed documents and collected user input; validate detected behavioral patterns based on repeatability and explainability criteria; store validated behavioral patterns; and apply stored behavioral patterns to generate predictions for new documents.

In some aspects, the techniques described herein relate to a computer program product, wherein analyzing documents includes: extracting content features from the documents using optical character recognition techniques; and applying natural language processing algorithms to identify key information within the extracted content.

In some aspects, the techniques described herein relate to a computer program product, wherein collecting user input includes: tracking user actions including field modifications, data entry patterns, and form navigation behaviors; and capturing contextual information including user role, device type, and time of interaction.

In some aspects, the techniques described herein relate to a computer program product, wherein detecting individual and collective behavioral patterns includes: employing machine learning algorithms to identify recurring patterns in user behavior across multiple documents; and utilizing time series analysis techniques to identify temporal dependencies in user behavior.

In some aspects, the techniques described herein relate to a computer program product, wherein the machine learning algorithms include clustering techniques, association rule mining, and sequence pattern mining.

In some aspects, the techniques described herein relate to a computer program product, wherein validating detected behavioral patterns based on repeatability criteria includes: performing statistical analysis to determine the frequency and consistency of observed patterns across different documents and time periods; and setting thresholds for pattern frequency and consistency to filter out noise or anomalies.

In some aspects, the techniques described herein relate to a computer program product, wherein validating detected behavioral patterns based on explainability criteria includes: generating human-readable explanations for detected patterns using natural language generation techniques; and assessing whether the system can provide a clear, understandable reason for why a particular pattern has been identified.

In some aspects, the techniques described herein relate to a computer program product, wherein generating human-readable explanations includes utilizing large language models to provide context-aware justifications for detected patterns.

In some aspects, the techniques described herein relate to a computer program product, wherein storing validated behavioral patterns includes: organizing patterns based on attributes including user characteristics, document types, and contextual factors; and implementing version control mechanisms to track changes in behavioral patterns over time.

In some aspects, the techniques described herein relate to a computer program product, wherein storing validated behavioral patterns further includes: utilizing graph databases to capture complex relationships between patterns and their attributes; and implementing efficient indexing techniques to facilitate quick retrieval of relevant patterns during inference.

In some aspects, the techniques described herein relate to a computer program product, wherein applying stored behavioral patterns to generate predictions for new documents includes: selecting relevant patterns based on contextual matching algorithms; combining predictions from multiple pattern-based models using ensemble methods; and generating confidence scores for each predicted field value.

In some aspects, the techniques described herein relate to a computer program product, further including: dynamically adjusting the user interface based on the predicted fields, including: reordering input fields to prioritize predicted fields with high confidence scores; and pre-populating fields with predicted values while visually distinguishing them from user-entered data.

In some aspects, the techniques described herein relate to a computer program product, further including: receiving user feedback on the generated predictions; updating the behavioral patterns based on the received user feedback; and refining future predictions based on the updated behavioral patterns.

In some aspects, the techniques described herein relate to a computer program product, wherein updating the behavioral patterns includes: employing online learning techniques to incorporate new feedback in real-time; and performing periodic retraining of the entire behavioral model using accumulated feedback data.

In some aspects, the techniques described herein relate to a computer program product, further including: implementing multilingual support in document analysis and pattern detection; and accommodating different date and currency formats across various languages and regions.

In some aspects, the techniques described herein relate to a computer program product, wherein the program instructions are further executable by the processor to cause the processor to: detect potential biases in the behavioral patterns based on user demographics or document characteristics; and implement measures to ensure fairness and ethical considerations in pattern detection and application.

In some aspects, the techniques described herein relate to a computer program product, wherein the program instructions are further executable by the processor to cause the processor to: integrate external data sources during pattern detection and validation; and incorporate broader contextual information to enhance the accuracy and relevance of detected behavioral patterns.

In some aspects, the techniques described herein relate to a computer program product, wherein the external data sources include industry databases, regulatory guidelines, and market trends relevant to the documents being processed.

### BRIEF DESCRIPTION OF THE DRAWINGS

FIG. 1 illustrates a flowchart of a method for analyzing documents and predicting form fields using behavioral patterns, according to aspects of the present disclosure.

FIG. 2 illustrates a flowchart depicting a workflow during bill creation by a user, according to an embodiment.

FIG. 3 illustrates a flowchart of an offline behavioral model training process, in accordance with example embodiments.

FIG. 4 illustrates a flowchart of an online behavioral model inference process, according to aspects of the present disclosure.

FIG. 5 illustrates a flowchart of a method for predicting document fields using behavioral modeling, according to an embodiment.

FIG. 6 illustrates a flowchart of a process for behavioral pattern detection and field prediction, in accordance with example embodiments.

FIG. 7 illustrates a block diagram of a behavioral model system for predicting input form fields, according to aspects of the present disclosure.

FIG. 8 illustrates a block diagram of a behavioral pattern learning system, according to an embodiment.

FIG. 9 illustrates a network system for enabling communication between various electronic devices, in accordance with example embodiments.

FIG. 10 illustrates a block diagram of a computing system, according to aspects of the present disclosure.

### DETAILED DESCRIPTION

The present disclosure relates to the field of document processing and data entry automation, specifically focusing on advanced techniques for predicting and populating input form fields using behavioral modeling and machine learning. This technology has applications across various industries where efficient and accurate document processing is crucial, such as finance, healthcare, and legal services.

Traditional document processing systems face significant challenges in accurately predicting and populating input form fields, particularly when dealing with incomplete or ambiguous information. Existing solutions often struggle with interpreting diverse document formats, have limited ability to infer missing information, and lack adaptability to individual user behaviors. These limitations result in reduced efficiency, increased manual intervention, and a higher likelihood of errors in data entry processes.

The present disclosure introduces a novel approach that combines document content analysis with historical user behavior patterns to predict input form fields, including those not explicitly present in the source document. By utilizing a machine learning behavioral model, the system can generate accurate predictions for missing or partially present fields, adapting to individual user preferences and learning even from collective behavioral patterns observed across multiple users.

Furthermore, the present disclosure incorporates a dynamic learning mechanism that continuously refines predictions based on user feedback, improving accuracy over time. The system also features multilingual support, enabling field prediction across various languages and accommodating different date and currency formats. Additionally, the disclosure includes methods for generating human-readable explanations for predictions, enhancing transparency and user trust in the automated process.

### Definitions and Use of Figures

Some of the terms used in this description are defined below for easy reference. The presented terms and their respective definitions are not rigidly restricted to these definitions—a term may be further defined by the term’s use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

Within the context of the present disclosure, "behavioral model" refers to model of user actions. In one embodiment, the behavioral model may include an artificial intelligence system used to predict user actions. For example, in one embodiment, a behavioral model may analyze historical data to predict how a user will populate specific form fields when processing a new document.

Within the context of the present disclosure, "collective behavioral patterns" refers to trends across users. For example, in one embodiment, collective behavioral patterns may reveal that most users consistently format invoice numbers in a specific way, even when the original document uses a different format.

### Descriptions of Exemplary Embodiments

The following description sets forth exemplary aspects of the present disclosure. It should be recognized, however, that such description is not intended as a limitation on the scope of the present disclosure. Rather, the description also encompasses combinations and modifications to those exemplary aspects described herein.

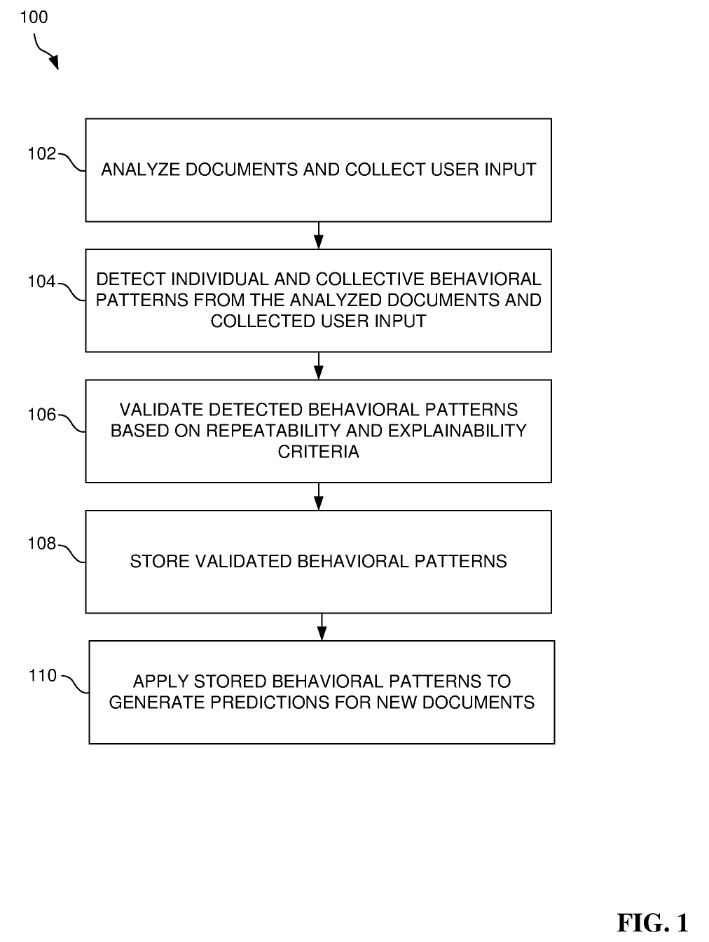

FIG. 1 illustrates a flowchart of a method 100 for analyzing documents and predicting form fields using behavioral patterns, in accordance with one embodiment. As an option, the method 100 may be implemented in the context of any one or more of the embodiments set forth in any previous and/or subsequent Figures and/or description thereof. Of course, however, the method 100 may be implemented in the context of any desired environment. Further, the aforementioned definitions may equally apply to the description below.

In operation 102, the method 100 begins with analyzing documents and collecting user input. This step involves processing multiple documents to extract relevant information and gathering historical data on how users have interacted with similar documents in the past. The document analysis may encompass various document types, including but not limited to invoices, contracts, financial statements, and legal forms. The system may employ natural language processing techniques to understand document structure and content semantics.

In some cases, the document analysis may involve optical character recognition (OCR) techniques to convert scanned documents into machine-readable text. Advanced OCR algorithms may be used to handle different fonts, layouts, and languages. The user input collection may include tracking how users manually fill out form fields, noting any modifications they make to pre-populated fields, and recording the frequency of certain data entry patterns. This may also involve capturing mouse movements, keystrokes, and time spent on each field to build a comprehensive user interaction profile.

In operation 104, the method 100 proceeds to detect individual and collective behavioral patterns from the analyzed documents and collected user input. This step may utilize machine learning algorithms to identify recurring patterns in how users interact with documents and fill out form fields. The system may employ various machine learning techniques such as clustering, association rule mining, or neural networks to uncover hidden patterns in user behavior.

In some aspects, the prediction engine may begin by training transformer-based language models on historical customer behavior. These models may learn usage patterns and, in some cases, apply guardrails to help ensure repeatability and explainability. Prior to deployment, the system may validate that each identified pattern can potentially be repeated under similar conditions and clearly explained, which may provide transparency for both internal and external stakeholders. This approach may assist in maintaining consistent outcomes and, in some instances, help build trust in the predictions generated by the system.

The behavioral patterns may include both individual user preferences and collective trends observed across multiple users. For example, the system may detect that a specific user consistently formats invoice numbers in a particular way, or that users across the organization tend to use a standard date format regardless of how dates appear in the original documents. The system may also identify patterns related to field dependencies, such as how the entry in one field influences the values in other fields.

In operation 106, the method 100 validates the detected behavioral patterns based on repeatability and explainability criteria. This step ensures that the identified patterns are reliable and can be justified logically. The validation process may involve statistical analysis to quantify the significance of observed patterns and filter out noise or anomalies.

The repeatability criterion checks if a pattern occurs consistently enough to be considered a genuine behavior rather than a random occurrence. This may involve setting thresholds for pattern frequency and consistency across different documents and time periods. The explainability criterion assesses whether the system can provide a clear, understandable reason for why a particular pattern has been identified and how it relates to the document content or user behavior. This may involve generating human-readable explanations using natural language generation techniques.

In some implementations, the system may measure repeatability by comparing the model's output against recent history. This comparison may typically involve the past two or three data points, or in cases of higher volume, up to five data points. The pattern may need to match user input across the maximum number of these past occurrences to be considered repeatable. For explainability, the system may utilize reasoning tokens and, in some instances, ensure there is a lineage of reasoning that connects to information found in the historical data or the current document. This approach may help provide a clear rationale for the patterns identified and predictions made by the system.

Further, in some implementations, the system may apply certain criteria to validate the behavioral patterns it detects. For repeatability, the system may, in some cases, apply the proposed pattern to prior bills and potentially require a complete match with the established ground truth set. This approach may help ensure that the identified patterns are consistent and reliable across multiple instances. In terms of explainability, the system may aim to trace every character in the pattern back to specific input fields. These input fields may include, but are not limited to, ground truth prior values, document extracted fields, and date information. This detailed tracing may, in some instances, provide a comprehensive understanding of how each element in the pattern relates to the original input data. By applying these validation methods, the system may strive to generate patterns that are both repeatable and explainable, potentially enhancing the reliability and transparency of its predictions.

In operation 108, the method 100 stores the validated behavioral patterns for subsequent use. This step involves saving the verified patterns in a structured format that can be easily accessed and applied in future document processing tasks. The storage system may utilize advanced database technologies, such as graph databases or distributed storage systems, to efficiently manage and retrieve complex pattern data.

In some implementations, the system may rely on predictions with the maximum historical support. When multiple patterns have equal support, the system may default to the most recently successful pattern. In certain cases, the system may offer multiple suggestions and rank them based on user feedback. This approach may help ensure that the system adapts to the most reliable pattern while potentially reflecting real-world usage. By considering both historical support and recent success, the system may be able to provide predictions that are both well-grounded in past behavior and responsive to current user preferences. The inclusion of multiple ranked suggestions may, in some instances, offer users flexibility while still prioritizing the most likely outcomes based on observed patterns.

The storage of behavioral patterns may include metadata such as the frequency of occurrence, the confidence level of the pattern, and/or any associated contextual information. This comprehensive storage approach allows the system to retrieve and apply the most relevant patterns when processing new documents. The system may also implement versioning and change tracking for stored patterns to analyze how behaviors evolve over time.

In operation 110, the method 100 applies the stored behavioral patterns to generate predictions for new documents. This step involves using the learned patterns to predict form field values for incoming documents, even when the required information is not explicitly present in the document itself. The prediction process may utilize ensemble methods, combining multiple pattern-matching algorithms to improve accuracy and robustness.

In some implementations, the system may prioritize patterns that have demonstrated the highest success rate for individual users. This approach may help ensure that predictions reflect not only general trends observed across the user base, but also personal nuances specific to each user. By considering individual user behavior, the system may be able to tailor its predictions to match the unique preferences and habits of each user. In some cases, this personalized approach may lead to more accurate and relevant predictions, as it takes into account the idiosyncrasies of individual user behavior that might deviate from broader trends. The system may, in certain instances, balance these individual patterns with more general patterns to provide predictions that are both personalized and informed by wider usage trends.

The prediction generation process may involve a combination of document content analysis and application of stored behavioral patterns. For fields that are partially present in the document, the system may use the available information as a starting point and then apply relevant behavioral patterns to complete or modify the field value. The system may also consider contextual factors such as document type, user role, or time of day when generating predictions, and may employ adaptive learning techniques to refine its predictions based on real-time user feedback.

In various embodiments, the method 100 may incorporate natural language processing techniques to enhance its ability to understand and interpret document content. This could allow the system to better recognize context and nuances in the text, leading to more accurate field predictions. Additionally, a feedback loop may be included where users can review and correct predictions, with this feedback being used to further refine the behavioral patterns. This continuous learning approach could help the system adapt to changing user behaviors and document formats over time. Further, multiple languages and regional formats may be provided. This could involve training the system on documents in various languages and teaching it to recognize and handle different date, currency, and number formats based on the document's origin or the user's preferences.

In some implementations, the system may capture real-time feedback from unaccepted suggestions and utilize this data to incrementally retrain and refresh its patterns. By updating the model based on recent user interactions, the system may be able to adapt to changing formats and behaviors without necessarily requiring a complete rebuild. This approach may allow for continuous improvement and refinement of the prediction engine, potentially enabling it to stay current with evolving user preferences and document formats. In certain cases, this incremental learning process may help the system maintain accuracy and relevance over time, even as user behaviors or document structures change. The ability to incorporate feedback in real-time may, in some instances, result in a more responsive and adaptive system that can quickly adjust its predictions based on the most recent user interactions.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

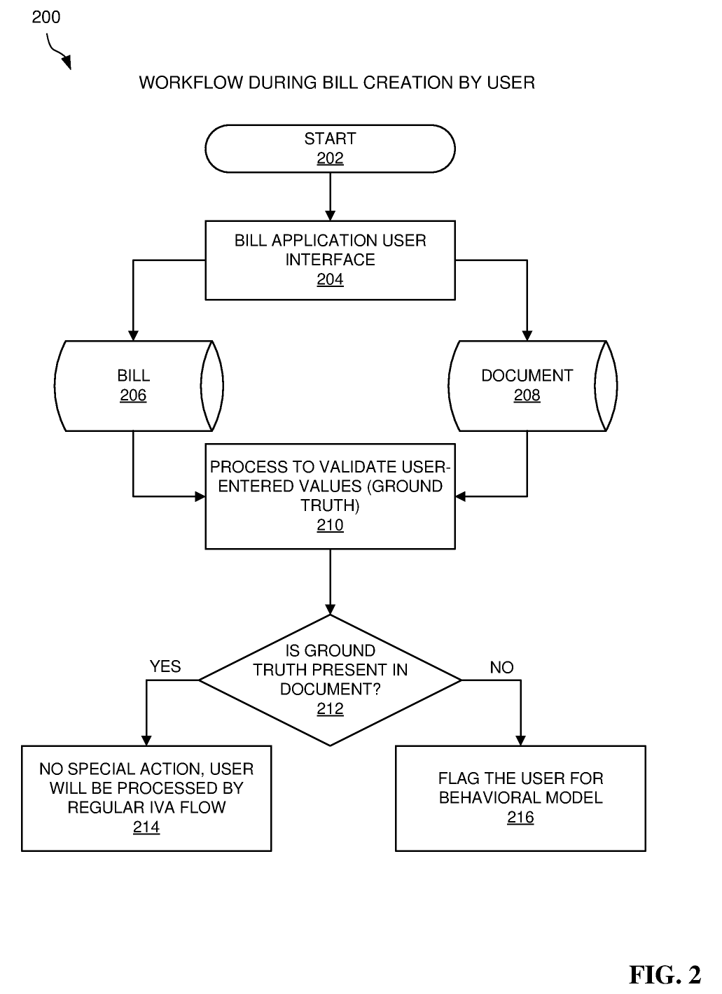

FIG. 2 illustrates a flowchart depicting a workflow 200 during bill creation by a user, in accordance with one embodiment. As an option, the workflow 200 may be implemented in the context of any one or more of the embodiments set forth in any previous and/or subsequent Figures and/or description thereof. Of course, however, the workflow 200 may be implemented in the context of any desired environment. Further, the aforementioned definitions may equally apply to the description below.

In operation 202, the workflow 200 begins with a start step 202, which initiates the bill creation process. This step may involve a user accessing a bill creation application or interface through a computing device. The computing device may be a desktop computer, laptop, tablet, smartphone, or any other suitable electronic device capable of running the bill creation application. The application may be accessed through a web browser, dedicated software, or a mobile app.

Additionally, the start step 202 may include user authentication procedures to ensure secure access to the bill creation system. These procedures may involve username and password verification, two-factor authentication, biometric recognition (such as fingerprint or facial recognition), or single sign-on (SSO) integration with other enterprise systems. In some cases, the start step 202 may also involve loading user preferences or default settings for the bill creation process. These preferences may include preferred currency, date format, language settings, or frequently used billing categories.

In operation 204, a bill application user interface is provided. This interface may present various input fields and options for the user to enter bill information. The input fields may include recipient details, itemized charges, tax calculations, payment terms, and additional notes or comments. The interface may also offer options for attaching supporting documents, selecting from predefined templates, or applying discounts. Additionally, this step may include dynamic elements that adapt based on the type of bill being created or the user's historical behavior. For example, the interface may automatically populate certain fields based on the selected bill type or adjust the layout to prioritize frequently used sections. In some cases, the interface step 204 may incorporate predictive text or auto-completion features to streamline data entry. These features may suggest recipient names, product descriptions, or pricing information based on previous entries or data from connected systems.

The operation 204 connects to two databases: a bill database 206 and a document database 208. These databases serve as repositories for historical bill information and document data, respectively. The connection may be established through secure database protocols, ensuring data integrity and confidentiality during information retrieval and storage.

The bill database 206 may store information such as previous bills, payment history, and user-specific billing patterns. This database may be structured to allow quick retrieval of relevant information, potentially using indexing techniques or caching mechanisms for frequently accessed data. The document database 208 may contain templates, standardized forms, and historical document data that can be used to assist in bill creation. This database may support various document formats, including PDFs, images, and structured data files, and may implement version control to track changes in templates over time.

In operation 210, data from both databases feeds into a validation step 210, which processes and validates user-entered values against ground truth. This step ensures the accuracy and consistency of the information being entered into the bill. The validation process may occur in real-time as the user enters data or as a separate step before bill finalization.

The validation step 210 may employ various techniques to verify the entered data, including cross-referencing with historical records, checking for logical inconsistencies, and applying business rules specific to the billing process. These techniques may involve pattern matching algorithms, statistical analysis to identify outliers, or rule-based systems that enforce company policies and regulatory requirements. The validation step may also include data normalization to ensure consistency in formats and units across different bills.

Following the validation step 210, the workflow 200 moves to a decision step 212, which determines whether ground truth is present in the document. This step assesses whether the entered information can be verified against known, reliable sources. The assessment may consider factors such as the presence of official stamps, digital signatures, or specific data patterns that indicate verified information.

The decision step 212 may utilize optical character recognition (OCR) techniques to extract raw data from physical documents, comparing this information with the user-entered data. The OCR process may involve preprocessing steps such as image enhancement and noise reduction to improve text recognition accuracy. In some cases, the decision step 212 may also involve machine learning algorithms to improve the accuracy of ground truth detection over time. These algorithms may be trained on large datasets of verified documents to recognize patterns and features indicative of ground truth.

Based on the determination made in the decision step 212, the workflow 200 branches into two paths. If the decision step 212 determines that ground truth is present, the workflow 200 proceeds to a processing step 214, where the user will be processed by regular intelligent virtual assistant (IVA) flow. This branching may be implemented using conditional logic within the workflow management system.

The processing step 214 may involve standard data entry procedures, potentially with assistance from an IVA to guide the user through the bill creation process. The IVA may provide contextual help, answer frequently asked questions, or offer suggestions based on best practices for bill creation. In some cases, the processing step 214 may include additional verification steps to compensate for the lack of ground truth. These steps may involve manual review processes, additional data source checks, or prompts for the user to provide supporting documentation.

Alternatively, if ground truth is not present, the workflow 200 moves to a flagging step 216, where the user is flagged for behavioral model processing. This step indicates that the entered information can be reliably verified and may be suitable for more advanced processing techniques. The flagging may involve setting a specific status in the user's profile or adding metadata to the current bill creation session.

The flagging step 216 may trigger the application of behavioral models to predict or suggest additional information based on the verified data and historical patterns. These behavioral models may use machine learning techniques such as neural networks or decision trees to analyze past billing behavior and make intelligent suggestions. In some cases, the flagging step 216 may also prioritize the bill for expedited processing or additional review. This prioritization may involve adjusting the bill's position in a processing queue or assigning it to specialized team members for handling.

The workflow 200 represents a structured approach for handling bill creation, incorporating validation against ground truth and determining appropriate processing paths based on document content analysis. This approach may enhance the accuracy and efficiency of the bill creation process. The workflow may be implemented using business process management (BPM) tools or custom software solutions that allow for flexible process definition and execution. The structured approach enables organizations to standardize their bill creation process while allowing for adaptability based on the specific characteristics of each bill and user interaction.

By integrating database information, user input, and document analysis, the workflow 200 may provide a more comprehensive and reliable bill creation process. The use of decision points and alternative processing paths allows for flexibility in handling various scenarios encountered during bill creation.

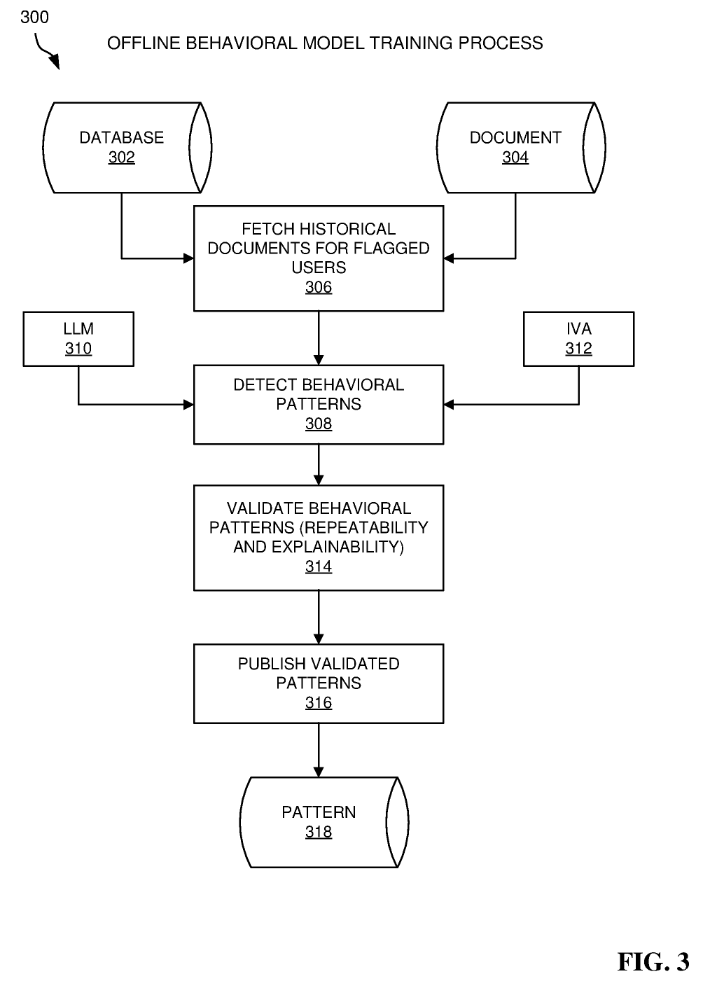

FIG. 3 illustrates a flowchart of an offline behavioral model training process 300, in accordance with one embodiment. As an option, the offline behavioral model training process 300 may be implemented in the context of any one or more of the embodiments set forth in any previous and/or subsequent Figures and/or description thereof. Of course, however, the offline behavioral model training process 300 may be implemented in the context of any desired environment. Further, the aforementioned definitions may equally apply to the description below.

The offline behavioral model training process 300 begins by receiving data from two sources: a database 302 and a document 304. These sources feed into a step 306 for fetching historical documents for flagged users. The database 302 may contain structured data such as user profiles, transaction histories, and metadata, while the document 304 source may include unstructured data like scanned invoices, contracts, or correspondence.

In operation 306, the offline behavioral model training process 300 retrieves historical documents associated with users who have been flagged for behavioral model processing. This step may involve querying the database 302 for user-specific document histories and accessing relevant documents from the document 304 storage. The flagging criteria may be based on factors such as user activity levels, error rates, or specific behavioral triggers identified in previous interactions.

In some cases, the step 306 may include data preprocessing techniques to standardize the format of retrieved documents, ensuring consistency in subsequent analysis steps. These techniques may involve text normalization, entity recognition, or data cleansing algorithms. The fetching process may also involve filtering documents based on relevance criteria or time frames to focus on the most pertinent historical data. This filtering may use machine learning algorithms to rank document relevance or apply rule-based systems to select documents within specific date ranges or containing particular keywords.

In step 308, the offline behavioral model training process 300 proceeds with detecting behavioral patterns. This step 308 receives input additionally from two components: a language model (LLM) 310 and an intelligent virtual assistant (IVA) 312. The LLM 310 may be a pre-trained model capable of understanding context and nuances in natural language, while the IVA 312 may be a system designed to simulate human-like interactions and decision-making processes.

The step 308 may employ various machine learning algorithms to identify recurring patterns in user behavior across the fetched historical documents. These algorithms may include clustering techniques, association rule mining, or sequence pattern mining. In some cases, the language model 310 may be used to extract semantic meaning from document content, analyzing textual data for context-dependent patterns. The intelligent virtual assistant 312 may provide insights based on historical user interactions, potentially using reinforcement learning techniques to model user decision-making processes.

The detected patterns may include both individual user behaviors and collective patterns observed across multiple users. For example, the system may identify common field entry formats, frequent data modifications, or typical document processing workflows shared by groups of users. These patterns could encompass preferences in data input methods, common error correction behaviors, or tendencies to use specific document templates or structures.

In operation 314, the detected patterns flow to a step 314 where behavioral patterns are validated for repeatability and explainability. This validation process ensures that identified patterns are consistent and can be logically justified. The validation step may employ cross-validation techniques to assess pattern reliability across different subsets of the data.

The repeatability validation may involve statistical analysis to determine the frequency and consistency of observed patterns. This may include calculating confidence intervals, performing hypothesis tests, or using bootstrapping methods to assess pattern stability. In some cases, the explainability validation may leverage the language model 310 to generate human-readable explanations for why certain patterns have been identified. These explanations may be crucial for building trust in the system and facilitating human oversight of the pattern detection process.

In some implementations, the system may capture the model's inference-time reasoning tokens and subsequently parse them into concise "explanation" text. This process may aim to elucidate the key factors and how they potentially influenced the final outcome. Even in cases where the patterns are complex, the model's reasoning chain may be distilled into a simple narrative that highlights why a specific prediction was made. This approach may help provide transparency and interpretability to the prediction process, potentially allowing users to understand the rationale behind the system's decisions. In certain instances, these explanations may be generated automatically, offering insights into the model's decision-making process without requiring extensive manual analysis. The ability to provide clear, understandable explanations may, in some cases, enhance user trust in the system and facilitate more informed decision-making based on the model's predictions.

After validation in step 314, the offline behavioral model training process 300 moves to a step 316 where validated patterns are published. The published patterns are then stored in a pattern database 318 for subsequent use. The publication process may involve creating formal descriptions of the patterns, including their detection criteria, statistical significance, and potential applications.

The step 316 may involve categorizing and indexing the validated patterns to facilitate efficient retrieval during online inference processes. This categorization may use taxonomies based on pattern types, user demographics, or document characteristics. In some cases, the pattern database 318 may employ version control mechanisms to track changes in behavioral patterns over time. This versioning may allow for analysis of pattern evolution and enable rollback to previous pattern sets if needed.

The offline behavioral model training process 300 demonstrates a resolution to challenges in traditional document processing systems by separating the pattern detection and learning phase from real-time application. This separation allows for more comprehensive analysis of historical data without impacting the performance of day-to-day document processing tasks. The offline nature of this process enables the use of computationally intensive algorithms and large-scale data analysis that might be impractical in real-time scenarios.

By processing multiple historical documents and input forms offline, the system can detect complex patterns that may not be apparent in individual documents or short-term user behaviors. This approach enhances the system's ability to capture nuanced behavioral trends and improve prediction accuracy.

In various embodiments, the offline behavioral model training process 300 may incorporate federated learning techniques to aggregate behavioral patterns across multiple organizations while preserving data privacy. This approach could allow for the identification of industry-wide trends without compromising sensitive user information. Further, the offline behavioral model training process 300 may be extended to support multi-modal data analysis, incorporating not only text-based documents but also images, audio recordings, or video content. This expansion could enable the system to detect behavioral patterns across a wider range of document types and user interactions.

In some implementations, the system may convert images to text using optical character recognition (OCR) techniques and subsequently treat this extracted text in a manner similar to other textual inputs. The system's transformer-based model may then process the combined textual inputs, which may include both text from documents and text extracted from images, to generate predictions. This approach may allow the system to incorporate information from various sources, potentially including both textual and image-based content, into its prediction process. In certain cases, this integration of multiple input types may enable more comprehensive analysis and potentially lead to more accurate predictions. The ability to process both document text and image-derived text through the same model may, in some instances, provide a unified approach to handling diverse input formats, potentially improving the system's flexibility and applicability across different document types.

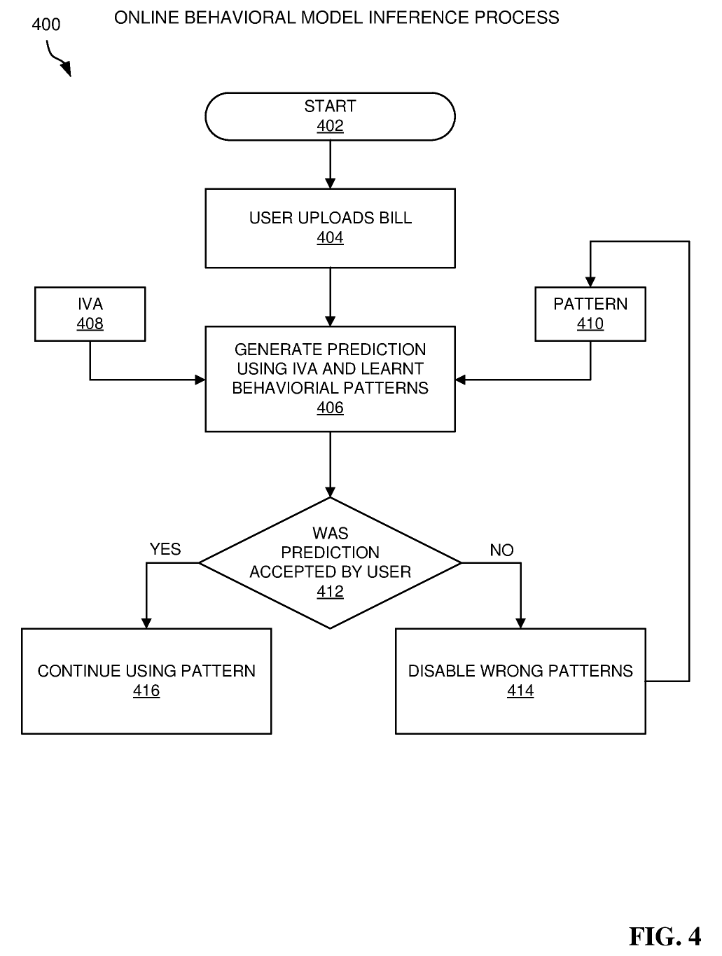

FIG. 4 illustrates a flowchart of an online behavioral model inference process 400, in accordance with one embodiment. As an option, the online behavioral model inference process 400 may be implemented in the context of any one or more of the embodiments set forth in any previous and/or subsequent Figures and/or description thereof. Of course, however, the online behavioral model inference process 400 may be implemented in the context of any desired environment. Further, the aforementioned definitions may equally apply to the description below.

In operation 402, the online behavioral model inference process 400 begins at a start step 402, followed by a step 404 where a user uploads a bill. The start step 402 may also involve initializing system logs to track the inference process and allocating computational resources for optimal performance. Additionally, this step may include checking for any system updates or new behavioral patterns that have been added since the last inference process was run.

The start step 402 may involve initializing the online behavioral model inference process 400, including loading necessary resources and preparing the system for bill processing. In some cases, the start step 402 may also include user authentication procedures to ensure secure access to the bill processing system. These authentication procedures may involve multi-factor authentication, such as combining password entry with biometric verification or a time-based one-time password (TOTP). The system may also perform a quick check of the user's permissions and access levels to determine which features and data they can interact with during the bill processing.

The step 404 may involve receiving a digital representation of a bill through various input methods, such as file upload, email attachment, or direct input through a user interface. In some cases, the step 404 may include preliminary processing of the uploaded bill, such as format conversion or basic data extraction. This preliminary processing may also involve checking the bill for completeness and flagging any missing or potentially erroneous information for user review. The system may employ optical character recognition (OCR) techniques for scanned documents to convert image-based bills into machine-readable text, enhancing the subsequent analysis and prediction steps.

In operation 406, the online behavioral model inference process 400 proceeds to generating a prediction using input from two sources: an IVA module 408 and a pattern module 410. This step may involve a complex orchestration of multiple machine learning models working in tandem to produce the most accurate predictions. The system may also employ ensemble methods, combining the outputs of various predictive models to enhance overall accuracy and robustness.

The IVA module 408 may analyze the content of the uploaded bill using natural language processing techniques to extract relevant information. In some cases, the IVA module 408 may also consider contextual information, such as the user's historical interactions or industry-specific knowledge. The IVA module 408 may utilize advanced semantic analysis to understand the intent and context behind specific bill entries, potentially identifying implicit relationships between different bill components. It may also cross-reference the extracted information with external databases or knowledge graphs to enrich the data and provide additional context for the prediction process.

The pattern module 410 may access and apply stored behavioral patterns to generate predictions for the bill fields. In some cases, the pattern module 410 may blend collective behavioral patterns observed across multiple users with individual patterns specific to the current user, prioritizing individual patterns when available and falling back to collective patterns when individual data is insufficient. The pattern module 410 may employ sophisticated weighting algorithms to determine the optimal balance between individual and collective patterns for each specific prediction. It may also utilize time-series analysis to identify evolving patterns in user behavior, allowing the system to adapt to changing user preferences or business practices over time.

In decision 412, after the prediction is generated, the online behavioral model inference process 400 determines whether the prediction was accepted by the user. This step may involve complex decision-making algorithms that consider multiple factors, such as the confidence level of the prediction, the user's historical acceptance rate, and the potential impact of the prediction on downstream processes. The system may also employ adaptive thresholds for acceptance, adjusting the criteria based on the specific context of the bill and the user's expertise level.

The decision step 412 may involve presenting the generated predictions to the user through a user interface and receiving user feedback. In some cases, the decision step 412 may include providing explanations for the predictions to help the user make an informed decision about accepting or rejecting them. These explanations may be generated using interpretable AI techniques, providing a clear rationale for each prediction in natural language. The system may also offer interactive visualizations that allow users to explore the factors contributing to each prediction, enhancing transparency and building trust in the inference process.

If the prediction is accepted by the user, the online behavioral model inference process 400 proceeds to a step 416, where the system continues using the pattern. This step may involve reinforcing the effectiveness of the applied patterns and potentially increasing their confidence scores for future predictions. The system may employ reinforcement learning techniques to continuously optimize the pattern selection and application process based on successful predictions. Additionally, this step may trigger a background process to analyze the accepted prediction in more detail, potentially identifying new sub-patterns or refining existing ones to enhance future prediction accuracy.

If the prediction is not accepted by the user, the online behavioral model inference process 400 moves to a step 414, where wrong patterns are disabled, and then feeds back to the pattern module 410 for future predictions. This step may involve analyzing the user's corrections to understand why the prediction was rejected and updating the pattern database accordingly. The system may employ sophisticated error analysis algorithms to categorize the type of rejection and its underlying causes, allowing for more targeted improvements to the prediction process. Furthermore, this step may initiate a learning process that generates new patterns or modifies existing ones based on the user's corrections, ensuring that the system continuously adapts to changing user needs and preferences.

The online behavioral model inference process 400 demonstrates a resolution to challenges in traditional document processing systems by incorporating real-time user feedback into the prediction process. This approach allows for continuous refinement of the behavioral model, adapting to individual user preferences and evolving document formats. By blending collective and individual behavioral patterns, the online behavioral model inference process 400 can provide personalized predictions while still leveraging broader trends observed across multiple users. This hybrid approach enhances the system's ability to handle diverse user behaviors and document types.

In various embodiments, the online behavioral model inference process 400 may incorporate explainable AI techniques to provide users with clear justifications for the generated predictions. This approach could enhance user trust in the system and facilitate more informed decision-making when accepting or rejecting predictions. Additionally, the online behavioral model inference process 400 may include a confidence scoring mechanism for predictions, allowing the system to prioritize high-confidence predictions and flag low-confidence ones for additional user review. This approach could help balance automation with human oversight in the bill processing workflow. Further, the online behavioral model inference process 400 may be extended to support multi-modal input, allowing users to upload bills in various formats such as images, scanned documents, or structured data files. This flexibility could enhance the system's applicability across different industries and use cases.

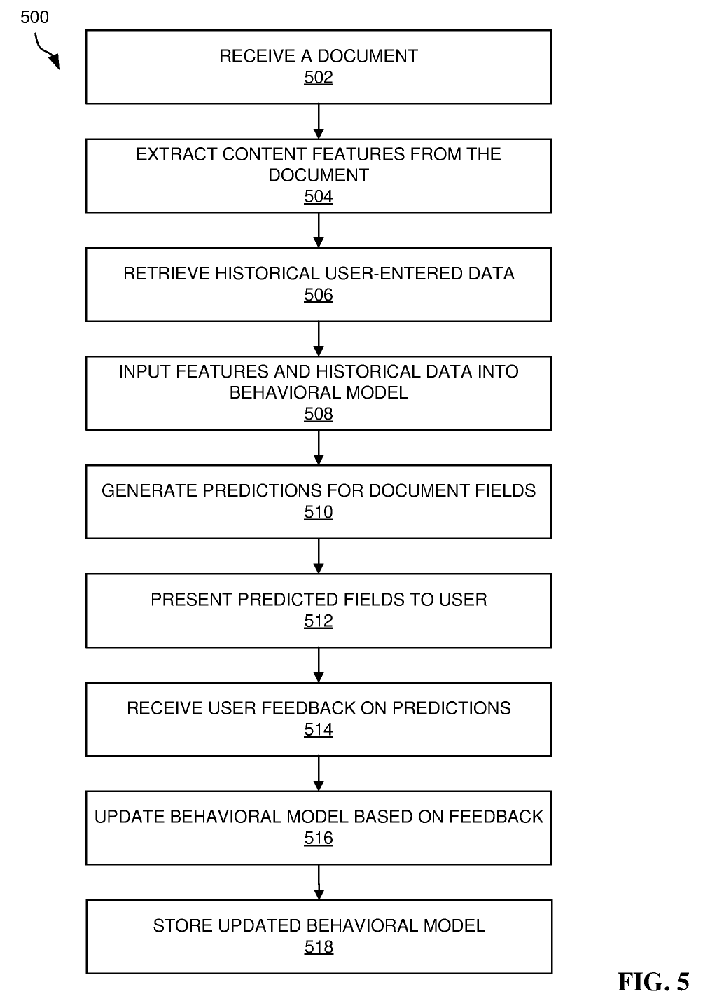

FIG. 5 illustrates a flowchart of a method 500 for predicting document fields using behavioral modeling, in accordance with one embodiment. As an option, the method 500 may be implemented in the context of any one or more of the embodiments set forth in any previous and/or subsequent Figures and/or description thereof. Of course, however, the method 500 may be implemented in the context of any desired environment. Further, the aforementioned definitions may equally apply to the description below.

In operation 502, the method 500 begins with a step 502 of receiving a document. This step may involve obtaining a digital representation of a document through various input methods, such as file upload, email attachment, or direct input through a user interface. The system may support multiple file formats and implement secure file transfer protocols to ensure data integrity during the upload process. Additionally, the method may include a document validation step to verify the authenticity and completeness of the received document before proceeding with further processing.

In some cases, the step 502 may include preliminary processing of the received document, such as format conversion or basic data extraction. The document may be in various formats, including but not limited to PDF, scanned images, or structured data files. The system may employ format detection algorithms to automatically identify the document type and apply appropriate preprocessing techniques. This preprocessing may also involve metadata extraction, such as creation date, author information, or document version, which can provide valuable context for subsequent analysis steps.

In operation 504, the method 500 proceeds to a step 504 of extracting content features from the document. This step involves analyzing the document to identify and extract key information that may be relevant for field prediction. The feature extraction process may utilize machine learning techniques to identify patterns and structures within the document, such as tables, headers, or specific data fields. Additionally, the system may employ domain-specific knowledge bases to enhance the accuracy of feature identification in specialized documents like legal contracts or medical records.

The content extraction process may utilize optical character recognition (OCR) techniques for scanned documents or text parsing algorithms for digital documents. In some cases, the step 504 may employ natural language processing techniques to understand the context and semantics of the extracted content. The system may also implement advanced OCR post-processing techniques, such as error correction and layout analysis, to improve the quality of extracted text from complex or low-quality scanned documents. Furthermore, the natural language processing may include named entity recognition and relationship extraction to identify key concepts and their connections within the document.

In some implementations, the system may utilize specialized libraries tailored to various document formats, such as PDF, DOCX, and others, to extract text directly from these files. For documents that are scanned or image-based, the system may employ an OCR engine to recognize the text. This OCR process may also provide a language code, which may allow the system to apply the appropriate tokenization and parsing techniques for the detected language. By using format-specific libraries and OCR capabilities, the system may be able to handle a wide range of document types and formats efficiently. In certain cases, this approach may enable the system to process both native digital documents and scanned paper documents with similar effectiveness. The ability to detect the document language and apply appropriate processing techniques may, in some instances, enhance the system's accuracy when dealing with multilingual documents or documents from diverse sources.

In operation 506, the method 500 continues with a step 506 of retrieving historical user-entered data associated with similar documents. This step involves accessing a database of previously processed documents and user interactions to gather relevant historical information. The system may implement efficient indexing and search algorithms to quickly retrieve relevant historical data from potentially large datasets. Additionally, the method may include a relevance scoring mechanism to prioritize the most applicable historical entries for the current document being processed.

The historical data retrieval may consider factors such as document type, user profile, and temporal patterns to identify the most relevant historical entries. In some cases, the step 506 may employ data anonymization techniques to protect user privacy while still leveraging collective behavioral patterns. The anonymization process may involve techniques such as data masking, tokenization, or differential privacy to ensure that individual user information cannot be identified while preserving the overall statistical properties of the data. The system may also implement access control mechanisms to ensure that only authorized personnel can access sensitive historical data.

In operation 508, the method 500 moves to a step 508 of inputting the extracted content features and historical user-entered data into a behavioral model. This step involves preparing and formatting the collected data for processing by the behavioral model. The data preparation process may include handling missing values, outlier detection, and feature scaling to ensure the input data is suitable for the behavioral model. Additionally, the system may implement feature selection algorithms to identify the most relevant inputs for the model, potentially improving prediction accuracy and reducing computational complexity.

The behavioral model may be a machine learning model, such as a neural network or a decision tree, trained on historical document processing data. In some cases, the step 508 may include data normalization or feature engineering to optimize the input for the behavioral model. The feature engineering process may involve creating derived features that capture complex relationships within the data, such as interaction terms or temporal aggregations. The system may also employ ensemble methods, combining multiple behavioral models to leverage their individual strengths and improve overall prediction performance.

In operation 510, the method 500 proceeds to a step 510 of generating predictions for document fields using the behavioral model. This step involves applying the trained behavioral model to the input data to predict values for various document fields, including fields that may not be present in the original document. The prediction process may utilize advanced techniques such as transfer learning to leverage knowledge from related domains when processing new document types. Additionally, the system may implement uncertainty quantification methods to provide a measure of reliability for each prediction, helping users assess the trustworthiness of the generated field values.

The prediction generation process may leverage large language models (LLMs) to enable high-quality predictions at scale. In some cases, the step 510 may include generating confidence scores for each prediction to indicate the model's certainty in its output. The system may employ techniques such as Monte Carlo dropout or ensemble methods to estimate prediction uncertainty and generate robust confidence scores. Furthermore, the method may include a post-processing step to ensure that the predicted field values are consistent with each other and adhere to any known constraints or business rules specific to the document type.

In operation 512, the method 500 continues with a step 512 of presenting the predicted document fields to a user. This step involves displaying the generated predictions through a user interface, allowing the user to review and interact with the predicted field values. The user interface may incorporate responsive design principles to ensure a consistent experience across different devices and screen sizes. Additionally, the system may implement accessibility features to make the prediction review process inclusive for users with diverse needs.

The presentation of predictions may include visual cues to distinguish predicted values from user-entered data. In some cases, the step 512 may provide explanations for predictions, leveraging the LLMs to generate human-readable justifications for the predicted values. The explanation generation process may utilize techniques from explainable AI, such as SHAP (SHapley Additive exPlanations) values or LIME (Local Interpretable Model-agnostic Explanations), to provide insights into the factors influencing each prediction. The system may also offer interactive visualizations that allow users to explore the relationships between different document fields and their predicted values.

In operation 514, the method 500 moves to a step 514 of receiving user feedback on the predicted document fields. This step involves capturing user interactions with the presented predictions, such as acceptances, modifications, or rejections of predicted values. The feedback collection system may implement real-time data validation to ensure that user-provided corrections are consistent and adhere to expected formats. Additionally, the method may include a mechanism for users to provide confidence ratings for their feedback, allowing the system to weigh user inputs based on their perceived reliability.

The feedback collection process may include tracking not only explicit user actions but also implicit feedback such as the time spent reviewing each prediction. In some cases, the step 514 may employ natural language processing techniques to analyze any comments or annotations provided by the user. The system may also implement sentiment analysis on user comments to gauge overall satisfaction with the predictions and identify areas for improvement. Furthermore, the feedback collection process may include a collaborative feature that allows multiple users to review and provide input on the same document, potentially improving the accuracy and completeness of the feedback.

In operation 516, the method 500 proceeds to a step 516 of updating the behavioral model based on the received user feedback. This step involves using the collected feedback to refine and improve the behavioral model's predictions for future documents. The model updating process may employ techniques such as incremental learning or online Bayesian updating to efficiently incorporate new information without requiring a full model retraining. Additionally, the system may implement concept drift detection algorithms to identify when the underlying patterns in the data are changing, triggering more substantial model updates when necessary.

The model updating process may employ online learning techniques to incorporate new feedback in real-time. In some cases, the step 516 may include periodic retraining of the entire model using accumulated feedback data to ensure long-term improvement in prediction accuracy. The retraining process may utilize distributed computing techniques to handle large volumes of feedback data efficiently. The system may also implement a model versioning system to track changes in the behavioral model over time, allowing for performance comparisons and the ability to rollback to previous versions if needed.

In operation 518, the method 500 concludes with a step 518 of storing the updated behavioral model for use in subsequent document field predictions. This step involves saving the refined model parameters and any newly learned patterns for future use. The storage process may include compression techniques to minimize the model's footprint while maintaining its predictive power. Additionally, the system may implement redundancy and backup mechanisms to ensure the durability and availability of the stored model across different geographical locations or data centers.

The storage process may include version control mechanisms to track changes in the behavioral model over time. In some cases, the step 518 may involve distributing updated model parameters to multiple instances of the system to ensure consistent performance across different users or departments. The distribution process may utilize efficient model compression and quantization techniques to reduce the bandwidth required for model updates. Furthermore, the system may implement a staged rollout strategy for model updates, allowing for gradual deployment and monitoring of the new model's performance before full-scale implementation.

The method 500 demonstrates a resolution to challenges in traditional document processing systems by incorporating behavioral modeling and continuous learning. By leveraging historical data and user feedback, the method 500 can generate accurate predictions for document fields, even when the required information is not explicitly present in the document itself. The use of large language models (LLMs) in the prediction generation process enables the method 500 to handle complex document structures and diverse field types with high quality at scale. This approach allows for more nuanced understanding of document content and user behavior patterns, leading to more accurate and contextually appropriate field predictions.

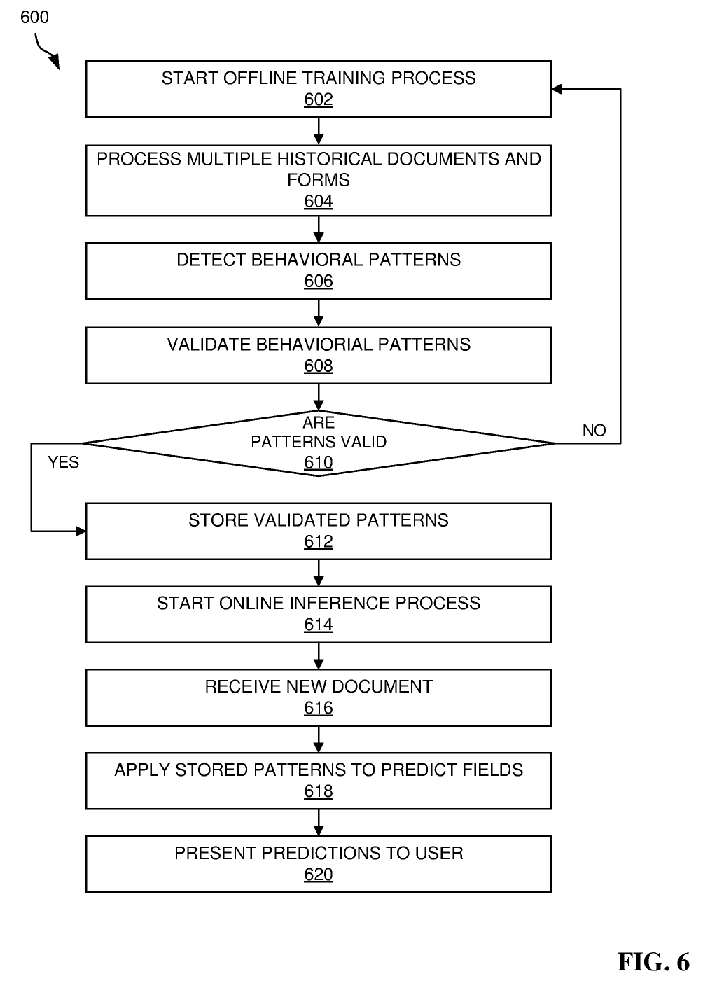

FIG. 6 illustrates a flowchart of a process 600 for behavioral pattern detection and field prediction, in accordance with one embodiment. As an option, the process 600 may be implemented in the context of any one or more of the embodiments set forth in any previous and/or subsequent Figures and/or description thereof. Of course, however, the process 600 may be implemented in the context of any desired environment. Further, the aforementioned definitions may equally apply to the description below.

In operation 602, the process 600 begins with a start offline training process step 602, which initiates the pattern learning phase. This step may involve preparing the system for analyzing historical data and detecting behavioral patterns. The preparation may include allocating computational resources, such as CPU cores and memory, to handle the intensive data processing tasks. Additionally, the system may perform a health check on all connected data sources and APIs to ensure uninterrupted access during the training process.

The start offline training process step 602 may include loading necessary resources, such as machine learning models and data processing algorithms. In some cases, the step 602 may also involve setting up parameters for the training process, such as defining the scope of historical data to be analyzed or specifying the types of patterns to be detected. The system may implement a configuration management system to version and track these parameters, allowing for reproducibility of training results. Furthermore, this step may include initializing logging and monitoring systems to capture detailed metrics throughout the training process for later analysis and optimization.

In operation 604, multiple historical documents and forms are processed to gather training data. This step involves analyzing a large volume of past documents and user interactions to identify recurring patterns and behaviors. The system may implement parallel processing techniques to handle large datasets efficiently, potentially utilizing distributed computing frameworks like Apache Spark or Hadoop. Additionally, the step may include data augmentation techniques to increase the diversity and robustness of the training dataset.

Additionally, the operation 604 may employ various data processing techniques, such as natural language processing and optical character recognition, to extract relevant information from diverse document formats. In some cases, the operation 604 may also include data cleaning and normalization procedures to ensure consistency in the analyzed data. The system may utilize advanced text preprocessing techniques, such as tokenization, lemmatization, and named entity recognition, to enhance the quality of extracted textual data. Furthermore, this step may incorporate domain-specific ontologies or knowledge graphs to enrich the extracted information with contextual understanding.

In operation 606, behavioral patterns are detected from the processed historical data. This step utilizes machine learning algorithms to identify recurring patterns in user behavior and document content. The system may employ a combination of supervised and unsupervised learning techniques to capture both known and previously unidentified patterns. Additionally, this step may include feature engineering processes to create derived attributes that capture complex relationships within the data.

The operation 606 may leverage large language models (LLMs) to analyze complex relationships between document fields and user inputs. In some cases, the step 606 may employ clustering algorithms to group similar behaviors and identify distinct patterns across different user segments or document types. The system may utilize advanced clustering techniques such as hierarchical clustering or DBSCAN to handle high-dimensional data and identify patterns at multiple granularity levels. Furthermore, this step may incorporate time series analysis to detect temporal patterns and trends in user behavior over extended periods.

In operation 608, the behavioral patterns are validated that have been detected. This step ensures that the identified patterns are reliable and consistent enough to be used for field prediction. The validation process may include cross-validation techniques to assess pattern stability across different subsets of the data. Additionally, the system may employ bootstrapping methods to estimate confidence intervals for pattern reliability metrics.

The operation 608 may involve statistical analysis to assess the frequency and consistency of detected patterns. In some cases, the operation 608 may use LLMs to generate human-readable explanations of the detected patterns, allowing for manual review and validation by domain experts. The system may implement a workflow management tool to coordinate the review process among multiple experts, tracking their feedback and reconciling conflicting opinions. Furthermore, this step may include automated checks for potential biases in the detected patterns, ensuring fairness and ethical considerations in the pattern validation process.

In decision step 610, it is determined whether the detected patterns are valid. This step acts as a quality control checkpoint to ensure only reliable patterns are used for field prediction. The decision process may utilize a scoring system that combines multiple validation metrics to produce an overall validity score for each pattern. Additionally, the system may implement a threshold-based approach with different levels of confidence, allowing for flexible pattern acceptance based on the specific requirements of different document types or use cases.

The decision step 610 may employ predefined criteria, such as minimum occurrence frequency or consistency thresholds, to evaluate pattern validity. In some cases, the decision step 610 may incorporate feedback from domain experts who review the LLM-generated explanations of the patterns. The system may utilize a weighted voting mechanism to combine expert opinions, potentially assigning higher weights to experts with demonstrated accuracy in previous validations. Furthermore, this step may include a feedback loop to the pattern detection process, allowing for iterative refinement of patterns that fall just short of the validity threshold.

In operation 612, if the patterns are determined to be valid in the decision step 610, the process 600 proceeds to a operation 612, where the validated patterns are stored for future use. This step involves saving the approved patterns in a structured format that can be easily accessed during the online inference phase. The storage process may include serialization of pattern objects to ensure efficient retrieval and deserialization during runtime. Additionally, the system may implement data compression techniques to optimize storage utilization while maintaining quick access to frequently used patterns.

The operation 612 may utilize a database management system to efficiently store and index the validated patterns. In some cases, the operation 612 may include metadata tagging to facilitate quick retrieval of relevant patterns based on document types, user characteristics, or other contextual factors. The system may employ advanced indexing techniques, such as inverted indexes or bitmap indexes, to enable fast querying of patterns based on multiple attributes. Furthermore, this step may include the implementation of a caching layer to store frequently accessed patterns in memory, reducing database load and improving retrieval speed during the online inference phase.

In operation 614, the online inference process is started. This step prepares the system to apply the stored patterns for real-time field prediction on new documents. The initialization process may include warming up caches with frequently used patterns and preloading inference models into memory to minimize latency. Additionally, the system may perform a quick health check on all components involved in the inference process, ensuring readiness for real-time operations.

The operation 614 may involve loading the necessary inference models and accessing the stored pattern database. In some cases, the operation 614 may also include initializing any runtime optimizations to ensure efficient pattern application during document processing. The system may employ just-in-time compilation techniques for inference models to optimize performance on the specific hardware configuration. Furthermore, this step may include setting up monitoring and alerting systems to track inference performance in real-time, allowing for quick detection and resolution of any issues that may arise during operation.

In operation 616, a new document is received for processing. This step involves obtaining a digital representation of a document that requires field prediction. The system may implement a queueing mechanism to handle high volumes of incoming documents, ensuring fair processing order and optimal resource utilization. Additionally, this step may include a quick assessment of the document complexity to estimate processing time and potentially prioritize simpler documents for faster turnaround.

The operation 616 may support various input methods, such as file uploads, email attachments, or direct data entry through a user interface. In some cases, the step 616 may include preliminary processing of the received document, such as format conversion or basic data extraction. The system may utilize adaptive preprocessing pipelines that adjust based on the detected document type and quality, applying specific enhancement techniques for low-quality scans or handling specialized formats. Furthermore, this step may incorporate real-time virus scanning and content validation to ensure the security and integrity of incoming documents before further processing.

In operation 618, the stored patterns are applied to predict fields in the new document. This step involves using the validated behavioral patterns to generate predictions for various document fields, including those that may not be explicitly present in the document. The prediction process may utilize ensemble methods, combining multiple pattern-matching algorithms to improve accuracy and robustness. Additionally, the system may implement adaptive pattern selection, dynamically choosing the most relevant patterns based on the specific characteristics of the input document.

The operation 618 may employ machine learning models that combine the stored patterns with the content of the new document to generate field predictions. In some cases, the operation 618 may use LLMs to provide human-readable explanations for the predictions, helping users understand the reasoning behind each suggested field value. The system may utilize attention mechanisms within the LLMs to highlight specific parts of the document that influenced each prediction, enhancing the transparency of the inference process. Furthermore, this step may include confidence scoring for each prediction, allowing for prioritization of high-confidence predictions and flagging of uncertain fields for human review.

In operation 620, t the predictions are presented to the user. This final step involves displaying the predicted field values and any associated explanations through a user interface. The presentation layer may implement responsive design principles to ensure a consistent experience across various devices and screen sizes. Additionally, the system may offer customizable views that allow users to adjust the level of detail in predictions and explanations based on their expertise and preferences.

The operation 620 may include visual cues to distinguish predicted values from user-entered data. In some cases, the operation 620 may allow users to interact with the predictions, such as accepting, modifying, or rejecting suggested field values, with this feedback potentially being used to further refine the behavioral patterns in future offline training cycles. The system may implement real-time feedback processing, immediately updating the confidence scores of related patterns based on user interactions. Furthermore, this step may include a collaborative feature that allows multiple users to review and provide input on the same document, potentially improving the accuracy and completeness of the final processed document through collective intelligence.

By incorporating both offline training and online inference phases, the process 600 can continuously improve its field prediction accuracy while maintaining efficient real-time performance. The use of LLMs to generate human-readable explanations for detected patterns and predictions enhances transparency and user trust in the system. Additionally, in various embodiments, the process 600 may extend the online inference phase to support adaptive learning, where user feedback on predictions is used to make real-time adjustments to the applied patterns. This could allow the system to quickly adapt to changing user behaviors or document formats without waiting for the next offline training cycle. Further, the process 600 may integrate with external data sources during the pattern detection and validation steps, incorporating broader contextual information to enhance the accuracy and relevance of detected behavioral patterns. This could involve accessing industry databases, regulatory guidelines, or market trends to inform the pattern validation process.

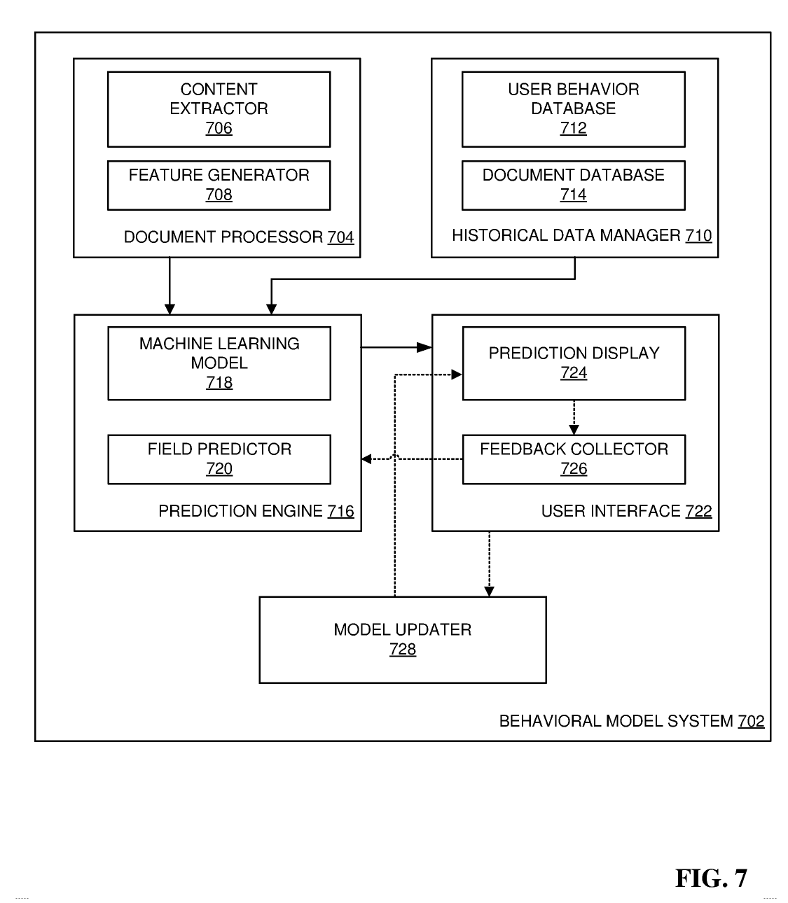

FIG. 7 illustrates a block diagram of a behavioral model system 702 for predicting input form fields, in accordance with one embodiment. As an option, the behavioral model system 702 may be implemented in the context of any one or more of the embodiments set forth in any previous and/or subsequent Figures and/or description thereof. Of course, however, the behavioral model system 702 may be implemented in the context of any desired environment. Further, the aforementioned definitions may equally apply to the description below.

The behavioral model system 702 includes a document processor 704 that processes input documents. The document processor 704 comprises a content extractor 706 and a feature generator 708. The content extractor 706 extracts content from input documents, while the feature generator 708 generates features from the extracted content. The document processor 704 may support a wide range of document formats, including PDFs, scanned images, and structured data files. It may also implement adaptive processing pipelines that adjust based on the detected document type and quality, applying specific enhancement techniques for low-quality scans or handling specialized formats.

In some cases, the content extractor 706 may employ optical character recognition (OCR) techniques to convert scanned documents into machine-readable text. The OCR process may include advanced pre-processing steps such as image denoising, skew correction, and binarization to improve text recognition accuracy. The feature generator 708 may utilize natural language processing algorithms to identify key information within the extracted content, such as dates, monetary amounts, or entity names. It may also employ named entity recognition and relationship extraction techniques to identify complex patterns and contextual information within the document.

The behavioral model system 702 also includes a historical data manager 710 that manages historical data used for prediction. The historical data manager 710 comprises a user behavior database 712 and a document database 714. The user behavior database 712 stores historical user-entered data, while the document database 714 maintains document information. The historical data manager 710 may implement efficient data compression and indexing techniques to handle large volumes of historical data while maintaining quick retrieval times.

In some cases, the user behavior database 712 may store anonymized user interaction data, such as field modification patterns or frequently used data formats. The anonymization process may involve advanced techniques like differential privacy to ensure user privacy while preserving the statistical utility of the data. The document database 714 may contain templates, standardized forms, and historical document data that can be used to assist in field prediction. It may also implement version control mechanisms to track changes in document templates and formats over time, allowing the system to adapt to evolving document structures.

The behavioral model system 702 further includes a prediction engine 716 that generates predictions for input form fields. The prediction engine 716 contains a machine learning model 718 and a field predictor 720. The machine learning model 718 processes inputs from both the document processor 704 and historical data manager 710. The field predictor 720 generates predictions based on the machine learning model's output. The prediction engine 716 may employ ensemble methods, combining multiple machine learning models to improve prediction accuracy and robustness across diverse document types.

In some cases, the machine learning model 718 may be a neural network trained on historical document processing data. The neural network architecture may include attention mechanisms to focus on relevant parts of the input document and capture long-range dependencies. The field predictor 720 may employ probabilistic algorithms to generate confidence scores for each predicted field value. It may also utilize Bayesian inference techniques to incorporate prior knowledge and uncertainty estimates into the prediction process.

The behavioral model system 702 also includes a user interface 722 that facilitates user interaction with the system. The user interface 722 comprises a prediction display 724 and a feedback collector 726. The prediction display 724 presents the predicted fields to users, while the feedback collector 726 captures user feedback on the predictions. The user interface 722 may implement responsive design principles to ensure a consistent experience across various devices and screen sizes, including mobile devices and tablets.

In some cases, the prediction display 724 may use color-coding or visual indicators to distinguish predicted values from user-entered data. It may also provide interactive visualizations that allow users to explore the factors influencing each prediction, enhancing transparency and user trust. The feedback collector 726 may track not only explicit user actions but also implicit feedback such as the time spent reviewing each prediction. It may employ advanced user behavior analytics to infer user satisfaction and identify areas for improvement in the prediction process.

The behavioral model system 702 also includes a model updater 728 that receives input from the user interface 722 (and in more particular, the feedback collector 726). The model updater 728 updates the machine learning model 718 based on the collected user feedback, allowing the system to refine its predictions over time. In more detail, the model updater 728 provides updates to prediction display 724 which in turn passes the updates to the feedback collector 726 which in turn provides it back to the prediction engine 716 comprising the machine learning model 718. In another embodiment, the machine learning model 718 may receive model updates directly from the model updater 728. The model updater 728 may implement safeguards to prevent overfitting to recent feedback, ensuring the model maintains good generalization performance across diverse document types and user behaviors.

In some cases, the model updater 728 may employ online learning techniques to incorporate new feedback in real-time. This may involve using techniques like stochastic gradient descent or online Bayesian updating to efficiently update model parameters without requiring a full retraining. The model updater 728 may also perform periodic retraining of the entire machine learning model 718 using accumulated feedback data to ensure long-term improvement in prediction accuracy. The retraining process may utilize distributed computing techniques to handle large volumes of feedback data efficiently, potentially leveraging cloud computing resources for scalability.

The behavioral model system 702 demonstrates a resolution to challenges in traditional document processing systems by integrating historical data analysis, machine learning, and continuous user feedback. By combining these elements, the system can generate accurate predictions for input form fields, even when the required information may not be explicitly present in the document itself. The use of a dedicated historical data manager 710 and a sophisticated prediction engine 716 allows the behavioral model system 702 to leverage both individual and collective user behaviors for more accurate field predictions. This approach enables the system to adapt to diverse document types and user preferences over time.

In various embodiments, the behavioral model system 702 may incorporate multilingual support in the document processor 704 and prediction engine 716. This extension could enable field prediction across various languages and accommodate different date and currency formats, enhancing the system's applicability in global contexts. Additionally, the behavioral model system 702 may extend the user interface 722 to include an explanation generator. This component could leverage large language models to provide human-readable justifications for predicted field values, enhancing transparency and user trust in the system's predictions.

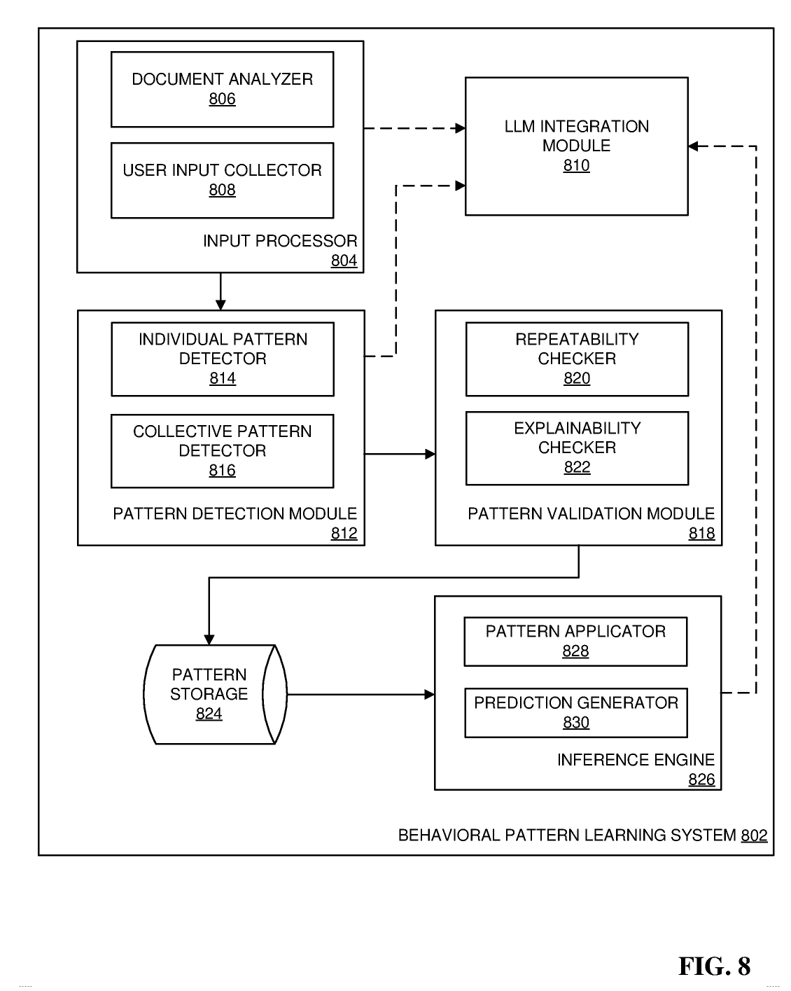

FIG. 8 illustrates a block diagram of a behavioral pattern learning system 802, in accordance with one embodiment. As an option, the behavioral pattern learning system 802 may be implemented in the context of any one or more of the embodiments set forth in any previous and/or subsequent Figures and/or description thereof. Of course, however, the behavioral pattern learning system 802 may be implemented in the context of any desired environment. Further, the aforementioned definitions may equally apply to the description below.

The behavioral pattern learning system 802 includes an input processor 804 that processes incoming data. The input processor 804 comprises a document analyzer 806 and a user input collector 808. The document analyzer 806 analyzes documents to extract relevant information, while the user input collector 808 gathers data from user interactions. The input processor 804 may implement parallel processing techniques to handle high volumes of incoming data efficiently. It may also include a data validation layer to ensure the quality and consistency of incoming information before further processing.

In some cases, the document analyzer 806 may employ optical character recognition (OCR) techniques to convert scanned documents into machine-readable text. The OCR process may include advanced image preprocessing steps such as deskewing, noise reduction, and binarization to improve text recognition accuracy. The user input collector 808 may track various user actions, such as field modifications, data entry patterns, and form navigation behaviors. It may also capture contextual information such as user role, device type, and time of interaction to provide a more comprehensive understanding of user behavior.

The behavioral pattern learning system 802 also includes an LLM integration module 810 that incorporates large language models into the system. The LLM integration module 810 may enhance the system's ability to understand and process complex document structures and user behaviors. This module may implement transfer learning techniques to adapt pre-trained language models to domain-specific tasks, improving performance on specialized document types or industry-specific terminology.

In some cases, the LLM integration module 810 may use pre-trained language models to generate contextual embeddings for document content and user inputs. These embeddings may help capture semantic relationships and nuances that might be missed by traditional text analysis methods. The module may also implement fine-tuning strategies to continuously improve the language model's performance on specific tasks or document types encountered in the system.

The behavioral pattern learning system 802 further includes a pattern detection module 812 that identifies recurring patterns in the processed data. The pattern detection module 812 comprises an individual pattern detector 814 and a collective pattern detector 816. The individual pattern detector 814 focuses on identifying patterns specific to individual users, while the collective pattern detector 816 analyzes patterns across multiple users. The pattern detection module may employ advanced machine learning techniques such as deep learning or reinforcement learning to identify complex, multi-dimensional patterns in user behavior and document structures.

In some cases, the individual pattern detector 814 may employ time series analysis techniques to identify recurring behaviors in a single user's document processing history. This may include the use of autoregressive integrated moving average (ARIMA) models or long short-term memory (LSTM) networks to capture temporal dependencies in user behavior. The collective pattern detector 816 may use clustering algorithms to group similar behaviors observed across different users or document types. It may also implement dimensionality reduction techniques such as t-SNE or UMAP to visualize and analyze high-dimensional pattern spaces.

The behavioral pattern learning system 802 also includes a pattern validation module 818 that ensures the reliability of detected patterns. The pattern validation module 818 comprises a repeatability checker 820 and an explainability checker 822. The repeatability checker 820 assesses the consistency of detected patterns, while the explainability checker 822 evaluates whether patterns can be logically justified. The pattern validation module may implement a multi-stage validation pipeline, incorporating both automated checks and human expert review to ensure the robustness and relevance of detected patterns.

In some cases, the repeatability checker 820 may use statistical analysis to determine the frequency and consistency of observed patterns across different documents or time periods. This may involve the use of hypothesis testing or bootstrapping methods to establish confidence intervals for pattern reliability. The explainability checker 822 may leverage the LLM integration module 810 to generate human-readable explanations for detected patterns, facilitating review by domain experts. It may also implement interpretable AI techniques such as SHAP (SHapley Additive exPlanations) values to provide detailed insights into the factors contributing to each pattern.

The behavioral pattern learning system 802 includes a pattern storage 824 that maintains validated patterns for future use. The pattern storage 824 may organize patterns based on various attributes such as user characteristics, document types, or contextual factors. The storage system may implement advanced data structures such as graph databases or tensor representations to capture complex relationships between patterns and their attributes efficiently.

In some cases, the pattern storage 824 may employ a database management system with efficient indexing to facilitate quick retrieval of relevant patterns during the inference process. This may include the use of bitmap indexes or inverted indexes to enable fast multi-attribute queries. The pattern storage 824 may also include version control mechanisms to track changes in behavioral patterns over time. This versioning system may allow for pattern rollback or comparison of pattern effectiveness across different time periods or system versions.

The behavioral pattern learning system 802 further includes an inference engine 826 that applies stored patterns to generate predictions. The inference engine 826 comprises a pattern applicator 828 and a prediction generator 830. The pattern applicator 828 selects and applies relevant patterns from the pattern storage 824, while the prediction generator 830 produces field predictions based on the applied patterns. The inference engine may implement caching mechanisms to store frequently used patterns or intermediate computation results, improving response times for common prediction scenarios.

In some cases, the pattern applicator 828 may use contextual matching algorithms to identify the most relevant patterns for a given document or user. This may involve the use of similarity measures in the embedding space created by the LLM integration module 810. The prediction generator 830 may employ probabilistic models to generate confidence scores for each predicted field value. It may also implement ensemble methods, combining predictions from multiple pattern-based models to improve overall accuracy and robustness.

The behavioral pattern learning system 802 demonstrates a resolution to challenges in traditional document processing systems by combining advanced pattern detection techniques with continuous learning and validation processes. By leveraging both individual and collective behavioral patterns, the system can generate more accurate and contextually appropriate field predictions. The integration of large language models through the LLM integration module 810 enhances the system's ability to understand complex document structures and user behaviors, enabling more nuanced pattern detection and explanation generation. This approach allows for improved adaptability to diverse document types and evolving user preferences.

In various embodiments, the behavioral pattern learning system 802 may extend the pattern validation module 818 to include a bias detection component. This component could analyze detected patterns for potential biases based on user demographics or document characteristics, ensuring that the system's predictions remain fair and unbiased across different user groups. Additionally, the behavioral pattern learning system 802 may implement an active learning approach in the inference engine 826. This could involve selectively querying users for feedback on low-confidence predictions, allowing the system to rapidly improve its performance on challenging or ambiguous cases while minimizing unnecessary user interactions.

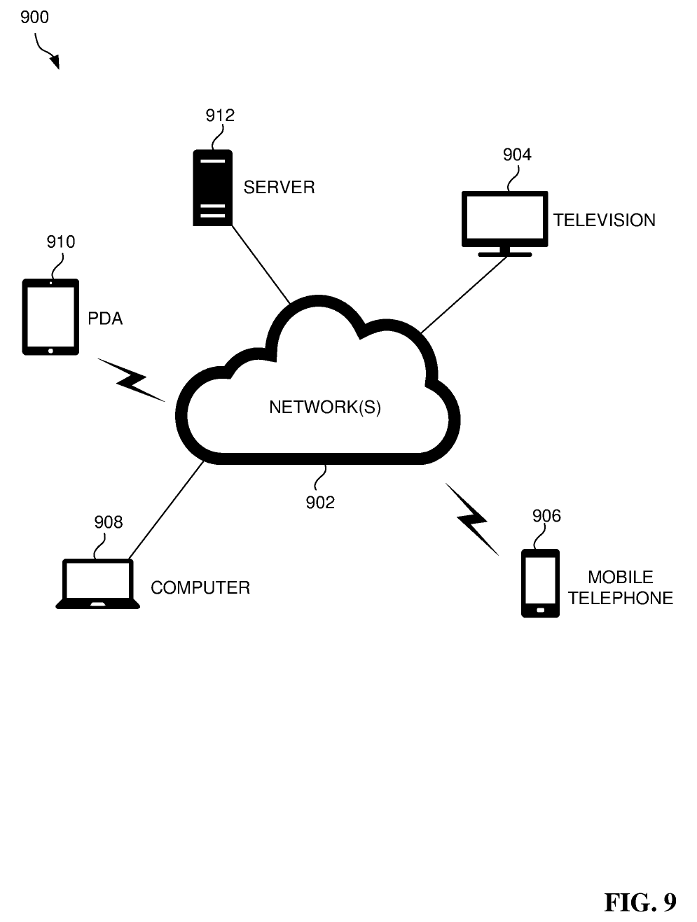

FIG. 9 illustrates a network system 900 for enabling communication between various electronic devices, in accordance with one embodiment. As an option, the network system 900 may be implemented in the context of any one or more of the embodiments set forth in any previous and/or subsequent Figures and/or description thereof. Of course, however, the network system 900 may be implemented in the context of any desired environment. Further, the aforementioned definitions may equally apply to the description below.

The network system 900 includes a network cloud 902 that serves as a central communication infrastructure connecting multiple devices. The network cloud 902 may facilitate data transmission and reception between various electronic devices within the network system 900. The network cloud 902 may employ cloud computing technologies to provide scalable and flexible communication services and utilize various networking protocols to ensure efficient and secure data transfer between connected devices.

A television device 904 connects to the network cloud 902, allowing for data transmission and reception. The television device 904 may receive streaming content, software updates, or interactive services through the network cloud 902. The television device 904 may include smart TV capabilities, enabling it to run applications and access online services, and may also serve as a display terminal for other devices connected to the network system 900.

A mobile telephone 906 communicates with the network cloud 902 through a wireless connection. The mobile telephone 906 may send and receive data, access cloud-based services, or interact with other devices in the network system 900 via the network cloud 902. The mobile telephone 906 may utilize cellular networks or Wi-Fi connections to access the network cloud 902, and may serve as a personal computing device, enabling users to access various services and applications within the network system 900.

A computer device 908 links to the network cloud 902, enabling data exchange and network access. The computer device 908 may be a desktop computer, laptop, or other personal computing device capable of connecting to the network cloud 902. The computer device 908 may use wired or wireless connections to access the network cloud 902 and may serve as a workstation for users to interact with various services and applications available through the network system 900.

A personal digital assistant (PDA) 910 connects to the network cloud 902, facilitating mobile data communication. The personal digital assistant 910 may be a handheld device or tablet computer that provides users with access to network services and applications. The personal digital assistant 910 may utilize mobile data networks or Wi-Fi connections to access the network cloud 902 and may offer users a portable means of interacting with the network system 900 and its connected devices.

A server device 912 connects to the network cloud 902, providing data storage and processing capabilities. The server device 912 may host applications, manage databases, or provide computational resources for other devices within the network system 900. The server device 912 may be a physical server located in a data center or a virtual server hosted in the cloud and may play a crucial role in managing and processing data for various services and applications within the network system 900.

The network system 900 employs a star topology, with the network cloud 902 acting as a central hub through which all devices communicate. This topology allows for efficient data routing and centralized management of network resources. The network cloud 902 enables data transmission between the television device 904, mobile telephone 906, computer device 908, personal digital assistant 910, and server device 912, allowing these devices to share information and resources across the network system 900. This interconnectivity facilitates seamless communication and collaboration between users of different devices.

The star topology of the network system 900 allows for scalable and flexible device management, as new devices can be easily added to the network by connecting them to the central network cloud 902. This approach simplifies network administration and enhances overall system reliability by reducing the number of potential points of failure.

In various embodiments, the network system 900 may incorporate advanced security protocols within the network cloud 902 to protect data transmission between connected devices. This may include encryption techniques, authentication mechanisms, and access control measures to ensure the privacy and integrity of communications within the network system 900.

In various embodiments, the network system 900 may extend its capabilities to support Internet of Things (IoT) devices, allowing for the integration of smart home appliances, environmental sensors, or industrial equipment. This expansion could enable more comprehensive automation and data collection capabilities across various domains.

In various embodiments, the network system 900 may implement edge computing technologies, distributing computational resources closer to the connected devices. This approach could reduce latency for time-sensitive applications and improve overall system performance, particularly for devices with limited processing capabilities such as the personal digital assistant 910 or certain IoT devices.

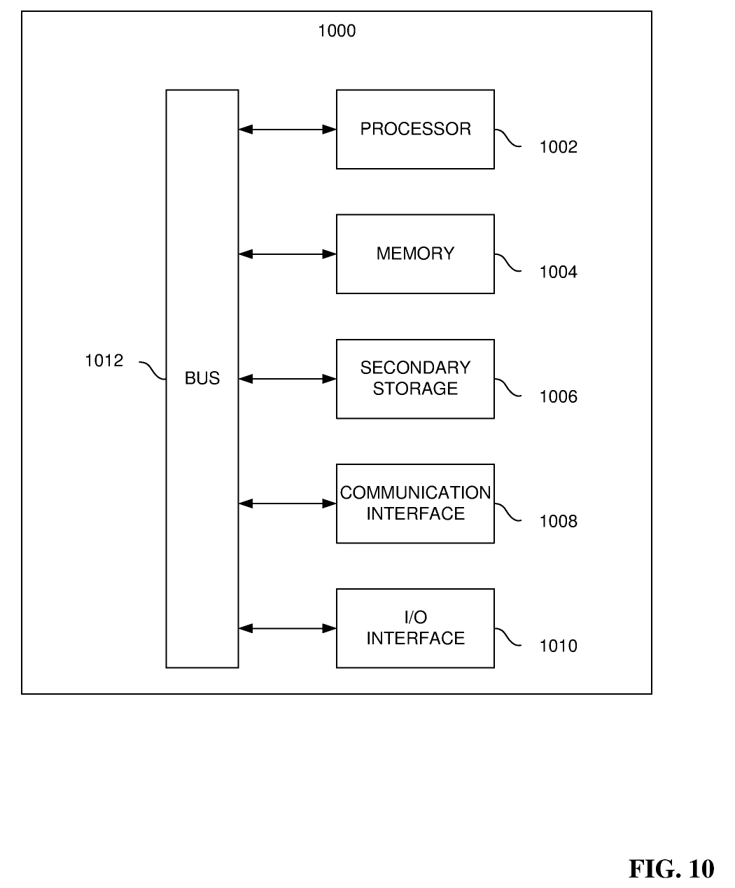

FIG. 10 illustrates a block diagram of a computing system 1000, in accordance with one embodiment. As an option, the computing system 1000 may be implemented in the context of any one or more of the embodiments set forth in any previous and/or subsequent Figures and/or description thereof. Of course, however, the computing system 1000 may be implemented in the context of any desired environment. Further, the aforementioned definitions may equally apply to the description below.

The computing system 1000 includes a processor 1002, memory 1004, secondary storage 1006, a communication interface 1008, and an input/output interface 1010, all interconnected via a system bus 1012.

A processor 1002 connects to the system bus 1012 and processes instructions and data for the computing system 1000. The processor 1002 may execute various algorithms, control system operations, and manage data flow within the computing system 1000. In some cases, the processor 1002 may be a multi-core processor capable of parallel processing, enhancing the overall performance of the computing system 1000. The processor 1002 may also include cache memory to store frequently accessed data and instructions for faster retrieval.

A memory 1004 couples to the system bus 1012 and stores data and instructions for processing by the processor 1002. The memory 1004 may include random access memory (RAM) for temporary storage of active data and program code. In some cases, the memory 1004 may also include read-only memory (ROM) to store permanent or semi-permanent data such as firmware or system configuration information. The memory 1004 may be organized into multiple levels or hierarchies to optimize data access and system performance.

A secondary storage 1006 connects to the system bus 1012 and provides additional data storage capacity. The secondary storage 1006 may include non-volatile storage devices such as hard disk drives, solid-state drives, or optical media for long-term data retention. In some cases, the secondary storage 1006 may serve as a backup for the memory 1004, storing less frequently accessed data or providing redundancy for critical information. The secondary storage 1006 may also host databases or file systems used by applications running on the computing system 1000.

A communication interface 1008 couples to the system bus 1012 and enables communication between the computing system 1000 and external devices or networks. The communication interface 1008 may support various network protocols and connection types, facilitating data exchange and remote access. In some cases, the communication interface 1008 may include multiple ports or adapters to accommodate different communication standards. The communication interface 1008 may also implement security measures such as encryption or authentication to protect data transmissions.

An input/output interface 1010 connects to the system bus 1012 and facilitates interaction between the computing system 1000 and external input/output devices. The input/output interface 1010 may support various peripherals such as keyboards, mice, displays, or printers. In some cases, the input/output interface 1010 may include specialized ports for connecting sensors, actuators, or other domain-specific devices. The input/output interface 1010 may also handle data conversion or formatting to ensure compatibility between the computing system 1000 and connected devices.

The system bus 1012 provides a communication pathway that allows data transfer between the processor 1002, memory 1004, secondary storage 1006, communication interface 1008, and input/output interface 1010. The system bus 1012 may use various architectures and protocols to manage data flow efficiently. In some cases, the system bus 1012 may employ multiple bus types or hierarchies to optimize data transfer between different components. The system bus 1012 may also include arbitration mechanisms to manage access conflicts and ensure fair resource allocation among system components.

The modular design of the computing system 1000 allows for easy upgrades or replacements of individual components without requiring a complete system overhaul. This approach enhances the longevity and adaptability of the computing system 1000, enabling it to accommodate evolving technological requirements and performance demands. In various embodiments, the computing system 1000 may incorporate specialized hardware accelerators connected to the system bus 1012 to enhance performance for specific tasks such as machine learning or cryptography. These accelerators may offload computationally intensive operations from the processor 1002, improving overall system efficiency and enabling real-time processing of complex algorithms.

In various embodiments, the computing system 1000 may implement virtualization technologies, allowing multiple operating systems or applications to run concurrently on the same hardware. This approach may enhance resource utilization and provide isolation between different software environments, improving security and system reliability. Additionally, the computing system 1000 may extend its capabilities to support multiple formats of dates and currencies, enhancing its versatility for global applications. The processor 1002 and memory 1004 may work together to implement format conversion algorithms, while the secondary storage 1006 may store locale-specific data to facilitate accurate interpretation and representation of diverse date and currency formats.

By way of a use-case scenario, and in various embodiments, a financial analyst at a multinational corporation implements the behavioral model system for processing invoices from various international vendors. The system receives a scanned invoice from a new Japanese supplier, which contains fields in Japanese and uses a date format unfamiliar to the analyst. The document processor extracts the content and generates features, while the historical data manager retrieves relevant data from previous Japanese invoices. The prediction engine, leveraging its machine learning model trained on multilingual data, accurately predicts the invoice date, due date, and total amount fields, converting them to the company's standard format. When the analyst reviews the predictions through the user interface, they notice that the system has also predicted a vendor ID field that wasn't explicitly present in the invoice, based on patterns observed in previous transactions with Japanese suppliers. The analyst accepts most predictions but adjusts the due date based on a recent policy change. The feedback collector captures this interaction, and the model updater uses this information to refine future predictions for Japanese invoices and due date calculations. This streamlined process significantly reduces the time and potential errors involved in processing international invoices, enabling the analyst to focus on higher-value financial analysis tasks.

The present disclosure addresses significant challenges in document processing and data entry automation that have long plagued existing systems. Prior art solutions have struggled to accurately predict and populate input form fields, particularly when dealing with incomplete or ambiguous information. These conventional systems often face limitations such as difficulties in interpreting diverse document formats, limited ability to infer missing information, and lack of adaptability to individual user behaviors. As a result, they frequently fail to generate accurate predictions for fields not explicitly present in the document, leading to increased processing time, reduced accuracy, and a higher workload for users who must manually review and correct automated entries.

The disclosed system overcomes these deficiencies through a novel approach that combines document content analysis with historical user behavior patterns to predict input form fields, including those not explicitly present in the source document. By utilizing a machine learning behavioral model that integrates both document-based content and historical user behavioral patterns, the system achieves a level of field prediction accuracy previously unattainable. Furthermore, the dynamic learning mechanism that continuously refines predictions based on user feedback ensures adaptability to individual user preferences and evolving document formats. This innovative approach not only enhances the accuracy of field predictions but also significantly reduces manual intervention, streamlines data entry processes, and improves overall efficiency in handling large volumes of documents across various industries such as finance, healthcare, and legal services.

As used here, a "computer-readable medium" includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms "a" and "an" and "the" and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., "such as") provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A computer program product for detecting and validating behavioral patterns in document processing, the computer program product comprising a computer readable storage medium having program instructions embodied therewith, the program instructions executable by a processor to cause the processor to:
analyze documents and collect user input;
detect individual and collective behavioral patterns from the analyzed documents and collected user input;
validate detected behavioral patterns based on repeatability and explainability criteria;
store validated behavioral patterns; and
apply stored behavioral patterns to generate predictions for new documents.

2. The computer program product of claim 1, wherein analyzing documents comprises:
extracting content features from the documents using optical character recognition techniques; and
applying natural language processing algorithms to identify key information within the extracted content.

3. The computer program product of claim 2, wherein collecting user input comprises:
tracking user actions including field modifications, data entry patterns, and form navigation behaviors; and
capturing contextual information including user role, device type, and time of interaction.

4. The computer program product of claim 1, wherein detecting individual and collective behavioral patterns comprises:
employing machine learning algorithms to identify recurring patterns in user behavior across multiple documents; and
utilizing time series analysis techniques to identify temporal dependencies in user behavior.

5. The computer program product of claim 4, wherein the machine learning algorithms include clustering techniques, association rule mining, and sequence pattern mining.

6. The computer program product of claim 1, wherein validating detected behavioral patterns based on repeatability criteria comprises:
performing statistical analysis to determine the frequency and consistency of observed patterns across different documents and time periods; and
setting thresholds for pattern frequency and consistency to filter out noise or anomalies.

7. The computer program product of claim 1, wherein validating detected behavioral patterns based on explainability criteria comprises:
generating human-readable explanations for detected patterns using natural language generation techniques; and
assessing whether the system can provide a clear, understandable reason for why a particular pattern has been identified.

8. The computer program product of claim 7, wherein generating human-readable explanations comprises utilizing large language models to provide context-aware justifications for detected patterns.

9. The computer program product of claim 1, wherein storing validated behavioral patterns comprises:
organizing patterns based on attributes including user characteristics, document types, and contextual factors; and
implementing version control mechanisms to track changes in behavioral patterns over time.

10. The computer program product of claim 9, wherein storing validated behavioral patterns further comprises:
utilizing graph databases to capture complex relationships between patterns and their attributes; and
implementing efficient indexing techniques to facilitate quick retrieval of relevant patterns during inference.

11. The computer program product of claim 1, wherein applying stored behavioral patterns to generate predictions for new documents comprises:
selecting relevant patterns based on contextual matching algorithms;
combining predictions from multiple pattern-based models using ensemble methods; and
generating confidence scores for each predicted field value.

12. The computer program product of claim 11, further comprising:
dynamically adjusting the user interface based on the predicted fields, including:
reordering input fields to prioritize predicted fields with high confidence scores; and
pre-populating fields with predicted values while visually distinguishing them from user-entered data.

13. The computer program product of claim 1, further comprising:
receiving user feedback on the generated predictions;
updating the behavioral patterns based on the received user feedback; and
refining future predictions based on the updated behavioral patterns.

14. The computer program product of claim 13, wherein updating the behavioral patterns comprises:
employing online learning techniques to incorporate new feedback in real-time; and
performing periodic retraining of the entire behavioral model using accumulated feedback data.

15. The computer program product of claim 1, further comprising:
implementing multilingual support in document analysis and pattern detection; and
accommodating different date and currency formats across various languages and regions.

16. The computer program product of claim 1, wherein the program instructions are further executable by the processor to cause the processor to:
detect potential biases in the behavioral patterns based on user demographics or document characteristics; and
implement measures to ensure fairness and ethical considerations in pattern detection and application.

17. The computer program product of claim 1, wherein the program instructions are further executable by the processor to cause the processor to:
integrate external data sources during pattern detection and validation; and
incorporate broader contextual information to enhance the accuracy and relevance of detected behavioral patterns.

18. The computer program product of claim 17, wherein the external data sources include industry databases, regulatory guidelines, and market trends relevant to the documents being processed.

19. A method, comprising:
at a computer system:
analyzing documents and collecting user input;
detecting individual and collective behavioral patterns from the analyzed documents and collected user input;
validating detected behavioral patterns based on repeatability and explainability criteria;
storing validated behavioral patterns; and
applying stored behavioral patterns to generate predictions for new documents.

20. A system, comprising:
a non-transitory memory storing instructions; and
one or more processors in communication with the non-transitory memory that execute the instructions to:
analyze documents and collect user input;
detect individual and collective behavioral patterns from the analyzed documents and collected user input;
validate detected behavioral patterns based on repeatability and explainability criteria;
store validated behavioral patterns; and
apply stored behavioral patterns to generate predictions for new documents.
